(19) United States
(12) Patent Application Publication
(10) Pub. No.: US 2009/0023458 A1
(43) Pub. Date: Jan. 22, 2009

(54) Method and System for Controlling the Operation of Movable Wireless Networks

(75) Inventor: Scott A. Mountney, Redmond, WA (US)

Correspondence Address: AT&T CORP., ROOM 2A207, ONE AT&T WAY, BEDMINSTER, NJ, 07921, US

(73) Assignee: AT&T Mobility II, LLC, Atlanta, GA (US)

(21) Appl. No.: 12/242,981

(22) Filed: Oct. 1, 2008

Related U.S. Application Data
(63) Continuation-in-part of application No. 11/877,795, filed on Oct. 24, 2007.
Application No. 11/877,795 is a continuation of application No. 10/938,569, filed on Sep. 13, 2004, now Pat. No. 7,324,813.
(60) Provisional application No. 60/549,920, filed on Mar. 5, 2004.

(51) Int. Cl. H04W 4/02

(52) U.S. Cl. 455/456.1

(57) ABSTRACT

A method of controlling the operating parameters of a non-stationary wireless network to conform to jurisdictional regulatory requirements is disclosed. A mobile base system determines its location and checks the operating parameters of the transceiver in the mobile base station against a database to determine whether the regulatory requirements have changed because of its location and to effect such a change. The mobile base station may alter the operating parameters of the transceiver in order to comply with regulatory requirements.

### CROSS-REFERENCE TO RELATED APPLICATION

This application is a continuation-in-part of U.S. patent application Ser. No. 11/877,795 filed on Oct. 24, 2007, which is a continuation of U.S. patent application Ser. No. 10/938,569 filed on Sep. 13, 2004, now U.S. Pat. No. 7,324,813, which claims priority to U.S. Provisional Application No. 60/549,920, filed on Mar. 5, 2004, all of which are hereby incorporated by reference.

### FIELD OF THE INVENTION

The disclosed method generally relates to wireless communication. More specifically, the disclosed method relates to a system and method for controlling the operational state of a mobile base station.

### BACKGROUND

Wireless devices have become ubiquitous in recent years. These devices include wireless or cell phones, information appliances, games and the like. Typically, these devices operate in a network that includes a stationary base station and a plurality of mobile nodes with each device comprising a node. A fixed wire-line network connects all of the base stations. The base station usually transmits at specified frequencies and at low power and consequently transmissions between the wireless device and the base station are substantially constrained within a specific area (cell).

The increased dependence on wireless devices has created a demand for services in moving conveyances such as aircraft, ships and trains. Currently, non-stationary or movable wireless network systems exist that are based within movable objects, such as ships, trains, aircraft, buses, and the like. Accordingly, as the movable object moves, so does a coverage area of the movable wireless network. By providing such services through movable wireless networks, passengers in such conveyances may be able to place telephone calls, receive e-mails and “surf” the net by connecting to a wireless network in the conveyance.

As a result of their changeable position, movable wireless networks can come into contact with stationary or other movable wireless networks. For example, the coverage area of the movable wireless network may overlap with the coverage area of a stationary network. When such an event happens, the respective wireless networks can undesirably interfere with each other, and thus result in interrupted service to their respective wireless network users. For example, the movable wireless network of a cruise ship may come into contact with a land-based stationary wireless network when the ship pulls into a port, or simply comes within close proximity to land. Since resources, such as transmitter power and frequency are subject to local and international rules, laws, regulations, and agreements, the use of the movable wireless network can be restricted. There may also be certain regulatory issues that arise when a conveyance moves across national boundaries. Accordingly, when an event occurs, the movable wireless network can be shutdown to avoid potential interference between the movable and stationary wireless networks, as well as violation of any local rules or regulations, and the movable wireless network users aboard the ship would then switch from the movable wireless network to communicate through the land-based stationary wireless network.

One technique of avoiding interference between a movable wireless network and stationary wireless network is described in PCT publication WO 01115338. The WO 01115338 publication teaches that an operator of a movable wireless station will generally not have a license to operate within the territory covered by a fixed base station, and may only be permitted to operate in international waters. Accordingly, the system taught in WO 01115338 includes a movable base station that is capable of detecting whether the movable base station is within the range of a fixed base station, such as a land-based stationary wireless network. In order to avoid interference with the fixed base station, when the movable wireless base station detects that it is within a particular range of a fixed base station, the movable wireless base station is shut down or the power of the movable wireless base station is reduced. This has the effect of avoiding interference between the wireless networks by having the movable wireless network defer to the fixed network whenever the movable wireless network determines that it is within a particular range of the fixed base station.

The radio frequency spectrum is a scarce resource. Two signals occurring simultaneously and over the same frequency can interfere with each other and nullify their benefits, spectrum must be managed to prevent interference. The dramatic increase in the use of wireless devices has increased the importance of the allocation and use of the spectrum. The regulatory framework has an international, regional and national component.

Spectrum at the international level is managed within the framework of the International Telecommunication Union (ITU). ITU is an agency of the United Nations and has among its major objectives the avoidance of radio interference and the fair and efficient use of spectrum and orbital resources. That mission is conferred primarily to its Radiocommunication Sector (ITU-R). ITU-R allocates bands of the radio frequency spectrum (a finite resource) to specific radio communications services, and assign and register radio frequencies to prevent interference between stations of different services and countries. The ITU-R maintains a Master International Frequency Register to ensure that each radio frequency use that could interfere with those of any other countries is registered. Registration of a frequency allocation in the Master Register confers to it international recognition and therefore reduces the probability of harmful interference.

Regional organizations also play a role in the development of policies for the management of the spectrum. For example, member states of the European Union are subject to regulation of the European Conference of Post and Telecommunications Administrations (CEPT), which provides detailed guidance to National Regulatory Authorities (NRA) on frequency allocations, harmonization and technical criteria.

After a set of spectrum bands have been allocated for a service by ITU, each nation adopts some or all of those bands for the service within its jurisdiction. Based on these allocations, a national table of frequency allocations or “band plan” is developed by a national regulatory administration that has been tasked with the function of spectrum management. Accompanying rules are also sometimes developed alongside each band in order to define the particular band's licensing, operating and technical rules. The national regulatory administration then assigns licenses to users giving them the exclusive right to operate on a specific frequency in a specific location or geographic area and under specified technical conditions (power limitations, permitted classes of emissions, mode of communication, antenna height, etc). Thus, a non-stationary wireless network operating across multiple regulatory jurisdictions must adapt their operating parameters to comply with the regulatory requirements of the jurisdiction where they are located at any point in time.

In a typical wireless network, mobile appliances (such as cell phones, wireless computers, etc,) are served by a base station, which is connected to a larger network. The base station and mobile appliances communicate by modulating radio waves with intelligence signals. The base station is typically a fixed device that can communicate with the mobile appliances over a fixed area. The base stations are in effect low-power multi-channel two-way radios. The base station typically includes a transceiver, which are a transmitter and receiver of radio signals. The base station also will include a controller that handles the allocation of radio channels, receives measurements from the mobile appliances, and may control handovers from base station to base station. Other devices may be incorporated into a base station such as transcoders that converts voice channel coding, or a packet control unit that is used for packet data.

A number of published applications describe the use of mobile base stations that are installed in ships, aircraft or other moving conveyances. US Patent Application Pub. No. 2003/0003874 A1, (Nitta, Jan. 2, 2003) discloses a method of controlling the operation of a mobile base station so as to avoid interference between the mobile base station and one or more stationary base stations.

Because some resources of wireless networks such as frequency or transmitter power have specific rules (based on local law, international law, treaty, bi-lateral, or multi-lateral agreements) governing how, how much, and where they can be used, this system is required to change the state of the non-stationary wireless network to comply with the rules respective to a particular scenario that the non-stationary wireless network 11 may encounter in its normal course of use. The specific rules governing where, what and how much power and or frequency the non-stationary wireless network can use may be either fundamental to the hardware and software of the specific non-stationary wireless system or regulatory in nature.

There is a need for a system having a mobile base station that can easily adapt to regulatory requirements in different areas.

### SUMMARY

The invention can provide a movable wireless network having a detector that senses a network event caused by a proximity of the movable wireless network to another wireless network. The invention can also include a controller that changes an operational state of the movable wireless network based on the network event so that the movable wireless network is able to operate with the other wireless network.

The invention can also provide a movable wireless network having a coverage area that includes a detector that detects a network event when the coverage area of the movable wireless network overlaps with a coverage area of another wireless network. The invention can further include a controller that changes an operational state of the movable wireless network when the detector detects the network event so that the movable wireless network is able to operate within the coverage area of the other wireless network.

A mobile network controller can continuously monitor a movable wireless network to determine whether a network event requires the movable wireless network to change an operational state. A network event can include situations where the movable wireless network moves into proximity with another network (movable or stationary) or when the movable wireless network interferes with another network (movable or stationary). A network event can be detected by a sensor, such as a position sensor, that can determine the position of the movable network relative to known stationary wireless networks. Further, a network event can be detected by a sensor that monitors the relevant frequency spectrum and measures frequency use and signal strength within the movable network or area surrounding the movable network to determine possible interference or overlap between the movable wireless network and another wireless network (movable or stationary).

Upon detection of a network event, the controller can change the operational state of a movable wireless network, such as changing an output power level (including shutting down) and transmission frequencies to minimize or avoid interfering with the stationary wireless network. Additionally, other operational states that the mobile network controller can change include codes of the system, such as mobile network codes (MNC) and mobile country codes (MCC) to correspond to a particular area of operation, a legal entity's license, or a country's jurisdiction.

A system is also disclosed comprising a non-stationary base station, at least one wireless appliance communicating with the base station and means to modify the operational state of the non-stationary base station depending on the location of the non-stationary base station.

A method for providing wireless communication services to at least one wireless appliance within a moving conveyance is disclosed that includes a disposing a base station within the moving conveyance, determining the location of the base station and modifying the operational state of the base station depending on the location.

These and other features and advantages of various exemplary embodiments of systems and methods according to this invention are described in, or are apparent from, the following detailed description of various exemplary embodiments of the systems and methods according to this invention.

### BRIEF DESCRIPTION OF THE DRAWINGS

Various exemplary embodiments of this invention will be described in detail, with reference to the following figures, wherein like numerals represent like elements, and wherein:

FIG. 1 is an exemplary block diagram of a communications system.

FIG. 2 is an exemplary block diagram of a movable wireless network controller.

FIG. 3 is an exemplary data structure of a movable wireless network memory.

FIG. 4A is an exemplary embodiment of a stationary wireless network separate from a movable wireless network.

FIG. 4B is an exemplary embodiment of a stationary wireless network merging with a movable wireless network.

FIG. 4C is an exemplary embodiment of a movable wireless network merged with a stationary wireless network.

FIG. 5 is a flow chart showing an exemplary process according to the present invention.

FIG. 6 is an exemplary diagram illustrating the non-stationary wireless network of this disclosure operating within a jurisdiction.

FIG. 7 is an exemplary diagram illustrating the non-stationary wireless network of this disclosure operating within a different jurisdiction.

FIG. 8 is an exemplary schematic of the components of the non-stationary wireless network of this disclosure.

FIG. 9 is an exemplary flow chart illustrating an embodiment for the control of the operating parameters of a mobile base station.

FIG. 10 is a block diagram of a non-limiting, exemplary wireless device that may be used in connection with an embodiment.

FIG. 11 is a block diagram of a non-limiting, exemplary processor in which the present subject matter may be implemented.

FIG. 12 is an overall block diagram of an exemplary packet-based mobile cellular network environment, such as a GPRS network, in which the present subject matter may be implemented.

FIG. 13 illustrates a non-limiting, exemplary architecture of a typical GPRS network as segmented into four groups.

FIG. 14 illustrates a non-limiting alternate block diagram of an exemplary GSM/GPRS/IP multimedia network architecture in which the present subject matter may be implemented.

### DETAILED DESCRIPTION

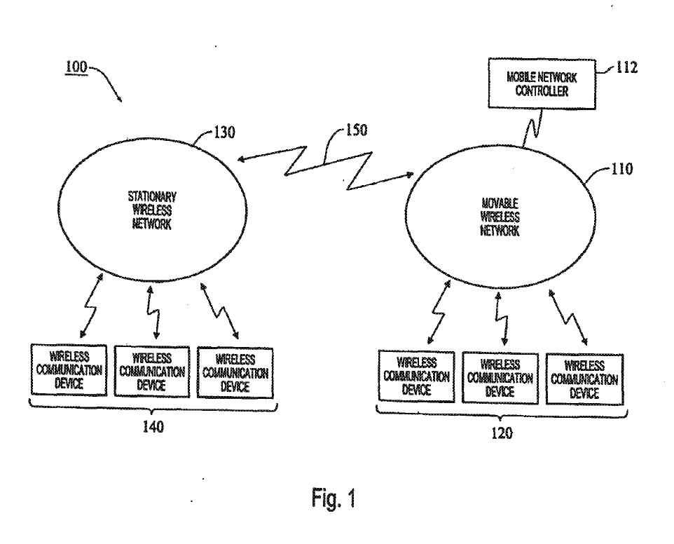

FIG. 1 is an exemplary block diagram of a communication system 100 for controlling the operation of a movable wireless network 110. As shown, the system 100 can include a movable wireless network 110, a mobile network controller 112, wireless communication devices 120 of the movable wireless network 110, a stationary wireless network 130, and wireless communication devices 140 of the stationary wireless network 130. Additionally, FIG. 1 shows that the movable wireless network 110 can be in communication with the stationary wireless network 130 via a communication link 150.

The movable and stationary wireless networks 110 and 130, respectively, may each be a single network or a plurality of networks of the same or different types. For example, the stationary wireless network 130 may be a cell or cells of a cellular network. Any combination of networks, whether a global, national, regional, wide-area, or local area, may be used without departing from the spirit and scope of the present invention. For the purposes of discussion, it will be assumed that both the movable wireless network 110 and stationary wireless network 130 are single cells within a wireless cellular network.

The wireless communication devices 120 and 140 can be devices of any type that allow for the transmission and/or reception of communication signals. For example, wireless communication devices 120 and 140 can be cellular telephones, wireless computers, wireless personal digital assistants (PDAs), wireless video phones, and the like. For the purposes of the following description of the present invention, it will be assumed that wireless communication devices 120 and 140 are cellular telephones.

While the mobile network controller 112 is shown as an independent unit coupled to the movable wireless network 110, it can also be incorporated into, or may be distributed throughout movable wireless network 110. For example, the mobile network controller 112 may be made part of the various network components (not shown) employed by movable wireless network 110 which are distributed throughout movable wireless network 110. Any configuration that permits control of the movable wireless network 110 can be used without departing from the spirit and scope of the present invention.

As shown, the movable wireless network 110 and stationary wireless network 130 can be in communication with each other, either directly or indirectly, via communication link 150. The communication link 150 may be of any type of connection that allows for transmission of information. Some examples include cellular telephone connections, satellite communication, radio frequency (RF), microwave, and the like. Additionally, the communication link 150 may be wired, such as copper wire, co-axial cable, optional fiber, or some combination of wired and wireless.

The mobile network controller 112 can continuously monitor the movable wireless network 110 to determine whether a network event requires the movable wireless network 110 to change an operational state. A network event can include situations where the movable wireless network 110 moves into proximity with another network (movable or stationary) or when the movable wireless network 110 interferes with another network (movable or stationary). A network event can be detected by a sensor, such as a position sensor, that can determine the position of movable wireless network 110 relative to known stationary wireless networks. Further, a network event can be detected by a sensor that monitors the relevant frequency spectrum and measures frequency use and signal strength within the movable network or area surrounding the movable network to determine possible interference or overlap between the movable wireless network and another wireless network (movable or stationary.)

Upon detection of a network event, the network controller 112 can change the operational state of a movable wireless network 110, such as changing an output power level (including shutting down) and transmission frequencies to minimize or avoid interfering with the stationary wireless network 130. Additionally, other operational states that the mobile network controller 112 can change include codes of the system, such as mobile network codes (MNC) and mobile country codes (MCC) to correspond to a particular area of operation, a legal entity's license, or a country's jurisdiction.

As one example of operation, upon detection of a network event, the mobile network controller 112 can communicate with the stationary wireless network 130 to determine whether it is compatible with the movable wireless network 110. Such a communication can occur via communication link 150. For example, two or more networks can be compatible with each other if they are owned and/or operated by the same company, legal entity, or a company with reciprocating rights of use. In such a case, the mobile network controller 112 can coordinate the operation of the movable wireless network 110 so that the stationary wireless network 130 and the movable wireless network 110 are merged together to effectively operate as a single wireless network. In such a merged or combined network formation, the movable wireless network 110 will be configured to seamlessly operate with the stationary wireless network 130. Under such coordinated operation, the movable wireless network 110 would not interfere with the stationary wireless network 130, even though the coverage of the movable wireless network 110 could well overlap with the coverage of the stationary wireless network 130.

In such a situation the movable wireless network 110 can extend the coverage of the stationary wireless network 130, or the movable wireless network 110 can be completely within the coverage area of the stationary wireless network 130. In either situation, the users of the wireless communication devices 120 of the movable wireless network 110 would enjoy uninterrupted service from either the stationary wireless network 130 or the movable wireless network 110.

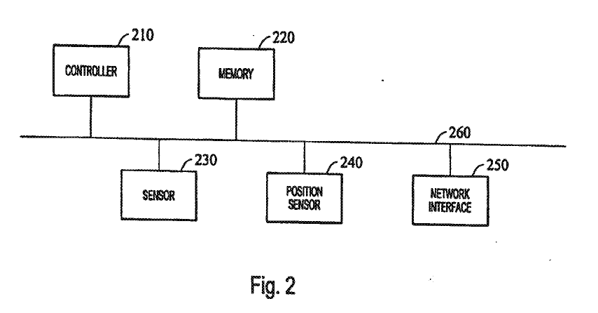

FIG. 2 is an exemplary block diagram of a mobile network controller 112. The mobile network controller 112 can include a controller 210, a memory 220, a sensor 230, a position sensor 240, and a network interface 250. The above components are coupled together via a control/data bus 260. The above architecture of the components is exemplary only. Other architectures of the components may be used without departing from the spirit and scope of the present invention.

The memory 220 can be any device that is capable of storing data and/or instructions for operating the controller 210, movable wireless network 110, and/or any components thereof. For example, the memory 220 may be magnetic, optical, electrical read only memory (ROM) or random access memory (RAM). Additionally, the data stored in the memory can be used by the controller 210 to compare measured data, such as data measured by the sensor 230 or position sensor 240, with that data stored in the network to determine whether a network event has occurred, or how to change an operational state of the movable wireless network 110.

Sensor 230 can be any device that is capable of detecting the presence of another wireless network. For example, the sensor 230 may be an antenna, or an array of antenna that can detect wireless communications in the relevant RF spectrum. Additionally, the sensor can sense the frequency, power, and phase of signals from a wireless network or another movable wireless network.

The position sensor 240 can be any device that is capable of determining a position of the movable wireless network 110. The position sensor 240 may be an independent unit as shown, or may be incorporated with the sensor 230. For example, the position sensor 240 can be a global positioning system (GPS), LORAN, gyroscope, compass, navigational system, and the like, which detect an actual position of the movable object, and thereby a position of the movable network. The position sensor 240 can also measure or detect the altitude, direction, velocity, or change in the velocity in the movable wireless network 110.

While the movable wireless network 110 is operating, the controller 210 can continually monitor the operating environment in which the movable wireless network is being operated. As described above, the controller 210 monitors to determine whether a network event has occurred. The controller 210 can monitor the movable wireless network 110, as well as the environment in which the movable wireless network 110 is operating, to detect a network event via the sensor 230 and/or the position sensor 240. Once a network event is detected, the controller 210 can change an operational state of the movable wireless network 110 via the network interface 250. Additionally, the controller 210 can compare information gathered by the sensor 230 and/or position sensor 240 in order to compare it with data in the memory 220 to determine how the operational state of the network should be changed.

The wireless network interface 250 can be any device that permits the controller 210 to communicate with and control the movable wireless network 110. For example, via the wireless network interface 250, the controller 210 can control one or more operational states of the movable wireless network 110. The operational states can include an amount of power, the antennas that are used, an antenna direction that is used, a phase, frequency, frequency plan, mobile network codes (MNC) and mobile country codes (MCC).

The network event can indicate that the movable wireless network 110 is about to cross, is crossing, or has crossed into operating area of a stationary wireless network 130 and/or another movable wireless network. As described above, in response to the network event, the operational state of the movable wireless network 110 can be modified to merge the movable wireless network 110 with the stationary wireless network 130 in such a way that the movable wireless network 110 does not interfere with the stationary wireless network 130 or other movable wireless networks. This can be accomplished by altering an operational state of the movable wireless network 110, such as the power level, frequencies, phase, antenna, antenna direction, mobile network codes (MNC), and mobile country codes (MCC). For example, if a network event indicated that the movable wireless network 110 was coming into contact with the stationary network 130, then the controller 210 could determine whether the stationary network 130 was a commonly owned-operated network either by communication with the stationary network 130 via communication link 150, review of network data stored in the memory 220, or communication with a remote control center via satellite or other technique. If it was determined that the stationary network 130 and movable wireless network 110 were commonly owned, then the movable wireless network 110 could set its operational states so as to be the same as the stationary network 130. For example, the controller 210 could set the movable network codes (MNC) and movable country codes (MCC) of the movable wireless network 110 to read the same as the stationary network 130. Accordingly, users of wireless devices in either network would not experience any interruption and could seamlessly switch between movable wireless network 110 and stationary wireless network 130. Accordingly, the movable wireless network 110 and stationary wireless network 130 can be merged together to form a single seamless wireless network. Alternatively, if the network event indicates that the movable object is about to cross, is crossing, or has crossed out of the operating area of the stationary wireless network 130 and/or another movable wireless network, the changes in the operational state of the movable wireless network 110 can be designed to withdraw the movable wireless network 110 from the stationary wireless network 130 and/or other moveable wireless networks. In other words, when a network event occurs that indicates to the controller 210 that the movable wireless network 110 is no longer in contact with a stationary network 130, then the operational state of the movable wireless network 110 can return to an optimal state of operation. For example, if a cruise ship were leaving port and entering back into international waters, the limitation, local or otherwise, on the wireless network operation would no longer exist. Accordingly, the movable wireless network 110 would be free to operate in a less restricted operating state, and an optimal selection of power, antenna, antenna direction, phase, frequency, mobile network codes (MNC) and mobile country codes (MCC) could be selected.

A network event can be triggered by one or more of the following: location of the movable object or wireless network; velocity of the movable object; change in velocity of the movable object; direction of the moveable object; altitude of the moveable object; location of the moveable object; detected frequency of transmitted signals from the stationary wireless network; detected power of transmitted signals from the stationary wireless network; detected phase of transmitted signals from the stationary network; known frequency of transmitted signals from the stationary wireless network; known phase of transmitted signals from the stationary wireless network; known frequency portfolio of transmitted signals from the stationary wireless network; known power of signals from the stationary wireless network; and known frequency plan of transmitted signals from the stationary wireless network. Additionally, the same network events can be trigged by another movable wireless network.

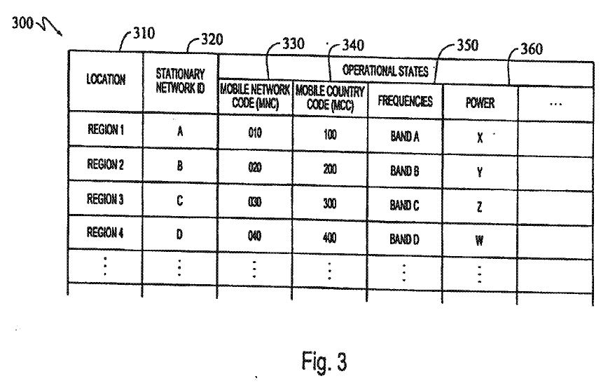

FIG. 3 shows an exemplary data structure for storing data corresponding to location related network events of the movable wireless network 110. The data structure 300 can include a field 310 for location codes and a field 320 for stationary network ID codes. Fields 330-360 are operational states corresponding to the network identified in field 320. Field 330 is the mobile network code (MNC), field 340 is the mobile country code (MCC), both of which correspond to the stationary network that is identified in field 320. Additionally, field 350 is a plurality of frequencies corresponding to the station area network ID in field 320 and field 360 is the power corresponding to the network identified in field 320.

Field 310 contains the physical location of the stationary network identified in field 320. The location of the field identified in 310 can be defined as the area covered by the stationary network. For example, in field 310, the first entry, “Region 1” can correspond to the coverage area of stationary network “A”. Likewise, the location “Region 2” identified in the second row of field 310 can correspond to the coverage area of stationary network “B”, identified in row 2 of field 320. These coverage areas can be RF coverage areas and/or legally defined coverage areas.

Accordingly, in operation, if the mobile controller 210 determines that a position of the movable wireless network 110 corresponds to a region stored in location field 310, then based on the exemplary data structures 300, the controller 210 will be able to determine the stationary network 130 with which the movable wireless network 110 is overlapping. For example, if a cruise ship were pulling into a port, and that port had a stationary network identified as stationary network “C” in column 3 of field 320, then as the mobile controller 210 monitored the position of the movable wireless network 110, for example, via position sensor 240, the controller 210 would determine that the position of the movable wireless network 110 was located within “Region 3”, and therefore that the movable wireless network 110 would be overlapping with stationary network “C”.

As described above, fields 330-360 describe the operational states of the corresponding stationary networks identified in field 320. Accordingly, in the above example, based on the knowledge that the movable wireless network 110 was operating in “Region 3”, the controller 210 would be able to determine the operational states corresponding to stationary network C. For example, the mobile network code (MNC) of stationary network C is “030”. The mobile country code (MCC) of the stationary network C is “300”. The frequencies used by stationary network C are identified as “Band C.” The power utilized by stationary network C is identified as “Z” in field 360. Accordingly, the movable wireless network 110 under the control of the mobile controller 210 could change the operational state of the movable wireless network 110 in order to co-exist with the stationary network C within the same operating environment.

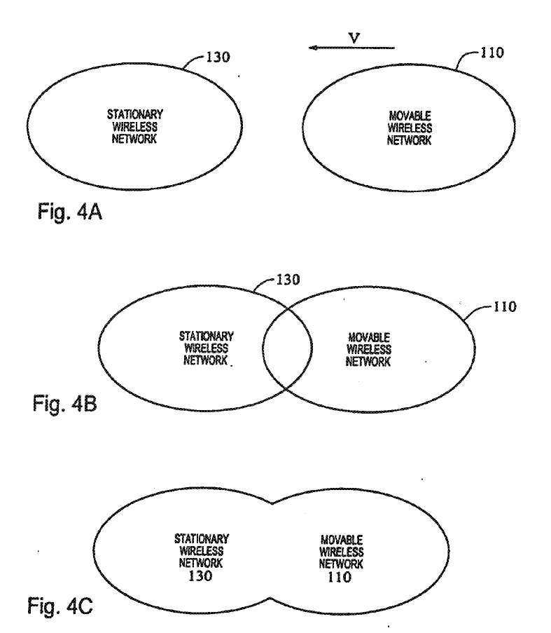

FIG. 4A shows an example where a movable wireless network 110 is approaching a stationary network 130 at a velocity V. While the networks are separated from each other, movable wireless network 110 could be free to operate at whatever frequency, power levels, mobile network code (MNC) and mobile country code (MCC), that the network wishes to best service its wireless device users. The stationary wireless network 130 would operate at its prescribed operational state in accordance with any licenses it was granted to operate, as well as any regional, or local wireless network communicating regulations.

However, as shown in FIG. 4B as the moveable wireless network continues to approach the stationary network 130, the coverage from the moveable wireless network begins to overlap with that of the stationary network 130. As described above, this triggers a network event, whereby the movable wireless network 110 can change the operational state of the moveable wireless network in order to avoid interfering with the stationary network 130. As also described above, the network event can be sensed by the sensor 230 when it detects the existence of another wireless network, such as communications in the relevant spectrum. Additionally, the network event can be determined by the controller 210, memory 220 and position sensor 240 when the location of the movable wireless network 110 corresponds to a known coverage area of a stationary wireless network 130. Further, as described above, the movable wireless network 110 can adjust its power, antennas, phase, frequency, mobile network codes and mobile country codes in order to avoid interfering with the stationary network 130.

As shown in FIG. 4C, once movable wireless network 110 has changed its operational state, movable wireless network 110 can then become part of the stationary wireless network 130, whereby users of either the movable wireless network 110 or stationary wireless network 130 can seamlessly pass between networks with uninterrupted service. As described above, the movable wireless network 110 and stationary wireless network 130 can be merged together by, for example, changing the codes, such as mobile country codes and mobile network codes, to be the same as those of the stationary wireless network.

In order for the movable wireless network 110 to communicate with the stationary wireless network 130, the movable wireless network 110 must be able to change its operational state including, but not limited to, the transmission frequency, frequency plan, phase, mobile network codes, mobile country codes, type of antenna, antenna direction, power, overall system power, and power of portions of the system to meet the specific rules (based on local law, international law, regulations, treaty, bilateral or multilateral agreements) governing how, how much and where the movable wireless networks 110 can be used. Accordingly, the exemplary embodiments of this invention are required to change the operational state (conditions) of the movable wireless network 110 when necessary to comply with the rules respective to a particular scenario that the movable wireless network 110 may encounter in its normal course of use.

For example, this system can be used to change codes respective to a particular area of operation, a legal entity's license or a country's jurisdiction such as mobile network code (MNC) and mobile country code (MCC). The specific rules governing where, and what and how much power and/or frequency the movable wireless network can use may be stored in memory 220 or hardwired into movable wireless network 110. By accessing the memory 220, for example, the movable wireless network may compare detected or measured data with predetermined data stored in memory 220 to detect an event, which would cause the controller 210 to change the operational state of the movable wireless network 110 to merge with the stationary wireless network 130 or withdraw from the stationary wireless network 130. By operating in this manner, multiple networks either stationary or movable may continue to operate and coordinate their operational state such that interference can be alleviated or eliminated.

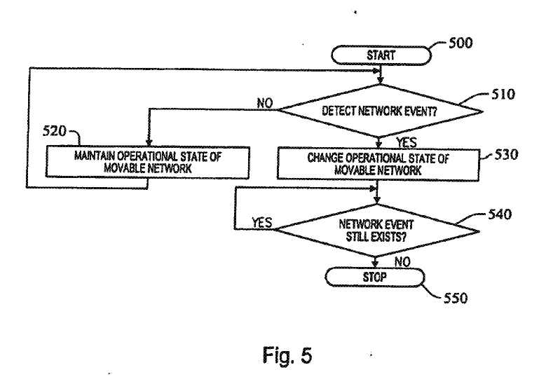

FIG. 5 is a flowchart showing an exemplary process of controlling a mobile wireless network. The process begins at block 500 where control passes to block 510.

In block 510, the environment of the movable wireless network is monitored to determine whether a network event has occurred. If a network event has occurred, the process proceeds to block 530; otherwise, if a network event has not occurred then the process proceeds to block 520.

At block 520, the operational state of the movable wireless network is maintained. Additionally, adjustments to the operational state of the wireless network may be made to maintain a best level of service for wireless communication devices using the mobile wireless network. In any event, the process returns to block 510, where the network environment is continually monitored for the existence of a network event.

At block 530, a network event has been detected, and the operational state of the movable wireless network is adjusted. The operational state of the movable wireless network can be changed so that the movable wireless network can become part of a stationary network. Accordingly, the movable wireless network will not interfere with the operation of a stationary wireless network.

Control then proceeds to block 540 where it is determined whether the network event still exists. If yes, then the process continues to loop back to block 540 until the network event ends. If the network event no longer exists, then the process proceeds to block 550 where the process ends.

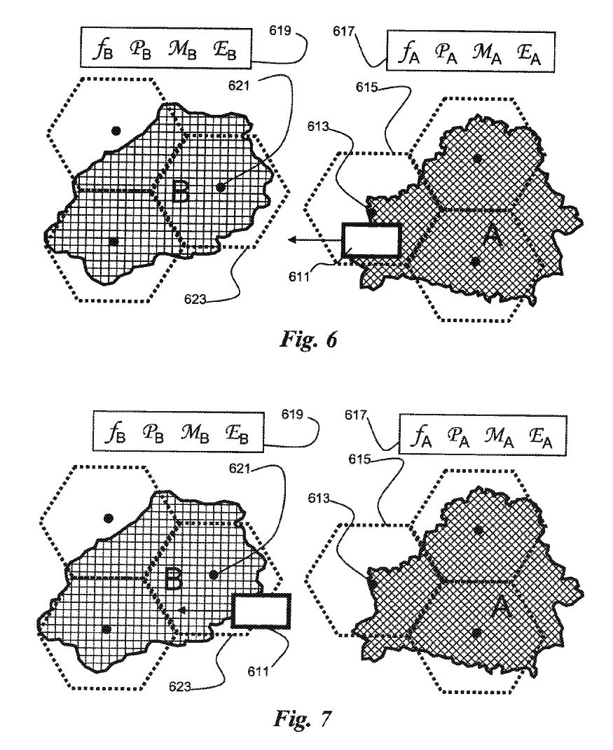

This disclosure further describes a method to control the operational state or mode of a non-stationary wireless network based on when, where or how it is operating in regard to one or more regulatory schemes. FIG. 6 illustrates a movable, non-stationary wireless network 611 operating in jurisdiction A. Within jurisdiction A there is a plurality of stationary base stations 613, each defining a cell 615. Associated with each jurisdiction are a set of regulatory requirements 617 including frequency (f_{A}); power (P_{A}); mode of communication (M_{A}); permitted classes of emissions (E_{A}), etc. When the non-stationary wireless network 611 is in jurisdiction A, the operating parameters of the network must conform to the regulatory requirements 617 for jurisdiction A. When the non-stationary wireless network 611 is in a moving conveyance such as an aircraft, or a ship that can travel to a different jurisdiction such as jurisdiction B shown in FIG. 6 with different regulatory requirements 619 designated as (f_{B}); (P_{B}); (M_{B}); and (E_{B}). As the non-stationary wireless network 611 moves from jurisdiction A to jurisdiction B, as illustrated in FIG. 7, the operating settings of the mobile network must be made to conform with the regulatory requirements 619 so that the non-stationary wireless network 611 can communicate with base station 621 within a cell 623 in compliance with the regulatory requirements of jurisdiction B.

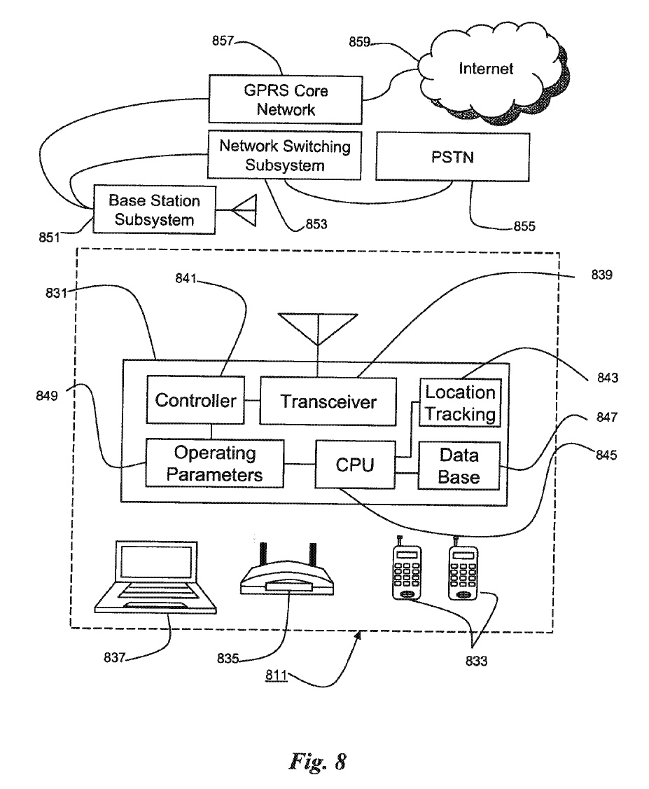

FIG. 8 illustrates the components of an alternative embodiment of a movable wireless network such as non-stationary wireless network 811. Non-stationary wireless network 811 may be a wireless network similar to those described herein, such as non-stationary wireless network 611 or movable wireless network 110. Non-stationary wireless network 811 may include a mobile base station 831 and a plurality of wireless appliances such as cell phones 833, wireless router 835 and portable computer 837. Although cell phones, routers, and portable computers are examples of wireless appliances that may be included within a network, other wireless appliances are contemplated and the description of this embodiment is not intended as a limitation to the examples of wireless appliances described herein.

The mobile base station 831 may include a transceiver 839 that is a radio frequency transmitter/receiver operating at certain specified frequencies. The transceiver 839 may communicate with wireless appliances such as cell phones 833, wireless router 835 and portable computer 837 and with the fixed base station in the cell where the non-stationary wireless network 811 is located.

The mobile base station 831 also may include a controller 841 that handles the allocation of radio channels, receives measurements from the wireless appliances of the non-stationary wireless network 811 and controls the operating parameters of transceiver 839. Mobile base station 831 may also include a location tracking function 843 provided by a device such as a global positioning system (GPS). Although a GPS system is described as an example of a location tracking function 843 other means to track location are known and the description of a GPS as an example is not intended as a limitation. Mobile base station 831 and/or non-stationary wireless network 811 may include components and functions described in FIG. 2 in regard to mobile network controller 112.

Associated with the location tracking function is a CPU 845 that receives an input from the location tracking function 843 and accesses a database 847 that includes information about the regulatory requirements associated with any location. Database 847 may be located with and/or attached to non-stationary wireless network 811 and/or components or devices associated therewith. Alternatively, CPU 845, and/or other components associated with non-stationary wireless network 811 may communicate with a remotely located database 847 using any means known to those skilled in the art. For the specific location of the non-stationary wireless network 811, the CPU 845 will return a set of operating parameters 849 that comply with the regulatory requirements for that jurisdiction. If the regulatory requirements are different from the operating parameters that the transceiver 839 is operating with, the controller 841 will change the operating parameters to those that comply with the regulatory requirements.

The mobile base station 831 serves to connect the non-stationary wireless network 811 with stationary base station subsystem 851 which can route signals to a network switching subsystem 853 which then connects to a public switched telephone network (PSTN) 855. Alternately, the mobile base station 831 may connect the non-stationary wireless network 811 to a stationary general packet radio service core network (GPRS Core Network 857) which may further connect the non-stationary wireless network 811 to the Internet 859.

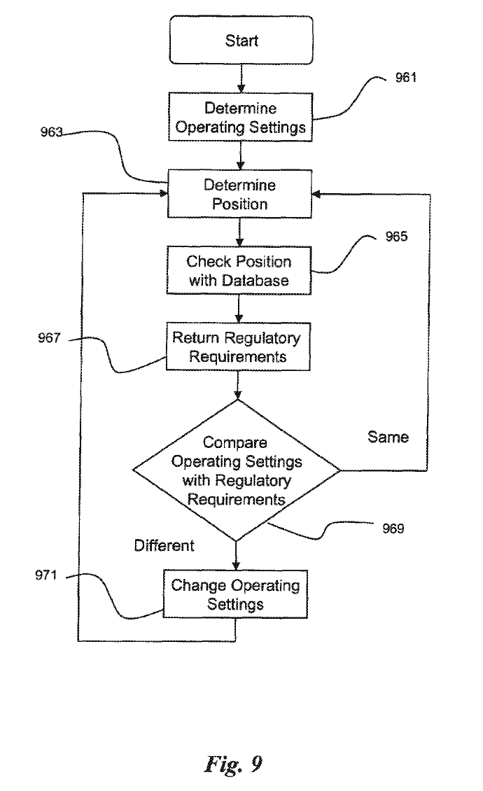

FIG. 9 is a flow chart illustrating a method for controlling the non-stationary wireless network 811 to conform to the regulatory requirements applicable to the jurisdiction where the non-stationary wireless network 811 is located. In FIG. 9, the controller 841 determines the operating settings of the transceiver 839 (block 961). The location tracking function 843 determines the position of the non-stationary wireless network 811 (step 963) and returns the results to a program operating in the CPU 845. The program operating in the CPU 845 searches the data base 847 for the regulatory requirements applicable to the position of the non-stationary wireless network 811 (step 965). The database 847 may include tabular data with areas (ranges of longitude and latitude) associated with regulatory requirements. Thus for a particular location of the mobile base station 831 (e.g. longitude and latitude), the program may search the database to identify the record that includes the field for the area within which the particular location can be found. Associated with that record on the database will be field values associated with the regulatory requirements for that location. The regulatory requirements for the relevant position are returned to the program operating in the CPU (step 967). The program then compares the operating settings to the regulatory requirements (step 969). If the regulatory requirements for the location are different from the operating settings, then the program instructs the controller 841 to change the operational settings to conform to the regulatory requirements. (step 971). If the regulatory requirements for the location are the same as the operating settings, then the program returns no instructions to the controller 841 and based on a predetermined cycle begins the process again.

The mobile base station 831 may use location or direction determining mechanisms and reference position data provided by the location tracking function 843 while applying an algorithm that can determine when, where and or how to change the operational state of the non-stationary wireless network 811. The algorithm of the system may take into consideration any one or some combination of the location, altitude, direction, velocity and change in velocity of the non-stationary wireless network 811.

The non-stationary wireless network 811 encompasses system of components that allow this particular type of wireless network to determine if and when it is proper to change the state of the system such as power level (including zero) or change the operational parameters including, but is not limited, to the power of the overall system or any portion of the system, the power, phase, direction, selection of antennas or frequency of the transmitting devices within the system.

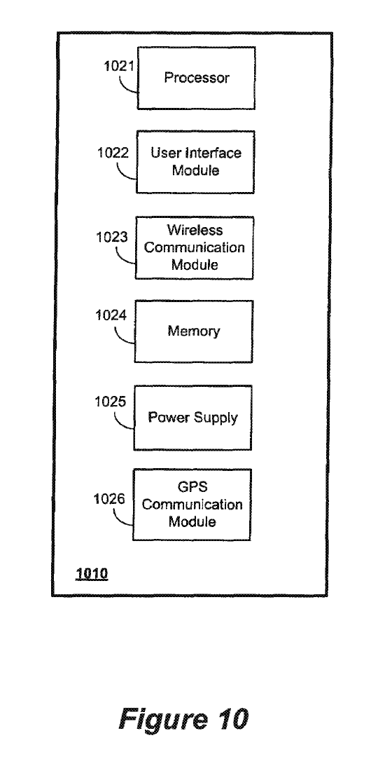

FIG. 10 illustrates an example wireless device 1010 that may be used in connection with an embodiment. References will also be made to other figures of the present disclosure as appropriate. For example, wireless communication devices 120 and 140, and cell phones 833, wireless router 835, and portable computer 837 may be of the type of device described in regard to FIG. 10, and may have some, all, or none of the components and modules described in regard to FIG. 10. It will be appreciated that the components and modules of wireless device 1010 illustrated in FIG. 10 are illustrative, and that any number and type of components and/or modules may be present in wireless device 1010. In addition, the functions performed by any or all of the components and modules illustrated in FIG. 10 may be performed by any number of physical components. Thus, it is possible that in some embodiments the functionality of more than one component and/or module illustrated in FIG. 10 may be performed by any number or types of hardware and/or software.

Processor 1021 may be any type of circuitry that performs operations on behalf of wireless device 1010. In one embodiment, processor 1021 executes software (i.e., computer readable instructions stored in a computer readable medium) that may include functionality related to determining if GPS location information is desirable and obtaining such information, for example. Such software may be a part of or may include, for example, GPS communication module 1026, to be discussed below. User interface module 1022 may be any type or combination of hardware and/or software that enables a user to operate and interact with wireless device 1010. For example, user interface module 1022 may include a display, physical and “soft” keys, voice recognition software, microphone, speaker and the like. Wireless communication module 1023 may be any type or combination of hardware and/or software that enables wireless device 1010 to communicate with, for example, movable wireless network 110, stationary wireless network 130, non-stationary wireless network 611, non-stationary wireless network 811, and/or GPRS core network 857. Memory 1024 enables wireless device 1010 to store information, such as GPS location information, contacts information, or the like. Memory 1024 may take any form, such as internal random access memory (RAM), an SD card, a microSD card and the like. Power supply 1025 may be a battery or other type of power input (e.g., a charging cable that is connected to an electrical outlet, etc.) that is capable of powering wireless device 1010.

GPS communication module 1026 may be any type or combination of hardware and/or software that enables wireless device 1010 to communicate with GPS location equipment. In one embodiment, wireless communication module 1023 may perform the functions of GPS communication module 1026. In an alternative embodiment, GPS communication module 1026 may be separate from wireless communication module 1023.

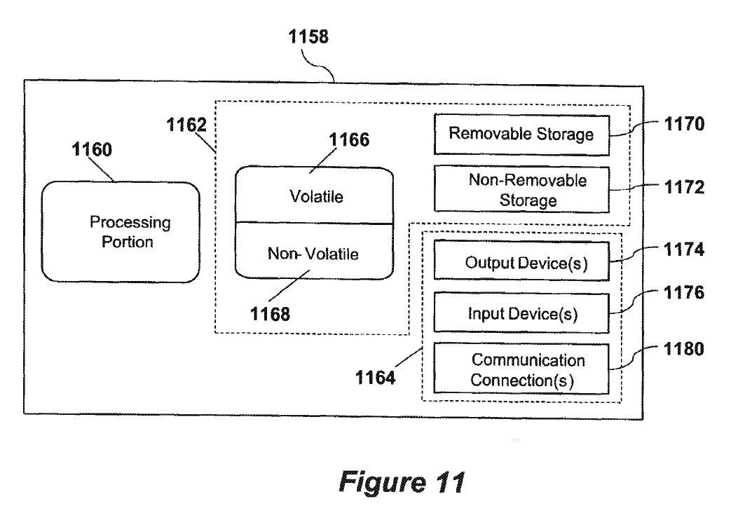

FIG. 11 is a block diagram of an example processor 1158 which may be employed in any of the embodiments described herein, including as one or more components of a communications device such as wireless communication devices 120 and 140, cell phones 833, wireless router 835, and portable computer 837, and/or as one or more components of communications network equipment or related equipment, such as any component of movable wireless network 110, stationary wireless network 130, non-stationary wireless network 611, non-stationary wireless network 811, and/or GPRS core network 857. It is emphasized that the block diagram depicted in FIG. 11 is exemplary and not intended to imply a specific implementation. Thus, the processor 1158 can be implemented in a single processor or multiple processors. Multiple processors can be distributed or centrally located. Multiple processors can communicate wirelessly, via hard wire, or a combination thereof.

The processor 1158 comprises a processing portion 1160, a memory portion 1162, and an input/output portion 1164. The processing portion 560, memory portion 562, and input/output portion 1164 are coupled together (coupling not shown in FIG. 11) to allow communications therebetween. The input/output portion 1164 is capable of providing and/or receiving components utilized to detect a change in location of a movable wireless network, send and receive information about network location, regulatory requirements, or any other information, calculate and effect changes in operating settings, or any perform any other aspect of the present subject matter. For example, the input/output portion 1164 is capable of providing/receiving communications and location information from/to database 847, location tracking 843, and CPU 845, sending instructions to controller 841, and executing programs and applications related to the adjustment of a non-stationary, movable wireless network and its associated components, or any combination thereof, as described above.

The processor 1158 can be implemented as a client processor and/or a server processor. In a basic configuration, the processor 1158 may include at least one processing portion 1160 and memory portion 1 162. The memory portion 1162 can store any information utilized in conjunction with transmitting, receiving, and/or processing non-stationary, movable wireless network operating parameters and location information, and/or processing associated communications. For example, as described above, the memory portion is capable of storing a database of regulatory requirements arranged by geographical location. Depending upon the exact configuration and type of processor, the memory portion 1162 can be volatile (such as RAM) 1166, non-volatile (such as ROM, flash memory, etc.) 1168, or a combination thereof. The processor 1158 can have additional features/functionality. For example, the processor 1158 can include additional storage (removable storage 1170 and/or non-removable storage 1172) including, but not limited to, magnetic or optical disks, tape, flash, smart cards or a combination thereof. Computer storage media, such as memory and storage elements 1162, 1170, 1172, 1166, and 1168, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 1158. Any such computer storage media may be part of the processor 1158.

The processor 1158 can also contain the communications connection(s) 1180 that allow the processor 1158 to communicate with other devices, for example through movable wireless network 110, non-stationary wireless network 611, and/or non-stationary wireless network 811. Communications connection(s) 1180 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection as might be used with a land-line telephone, and wireless media such as acoustic, RF, infrared, cellular, and other wireless media. The term computer readable media as used herein includes both storage media and communication media. The processor 1158 also can have input device(s) 1176 such as keyboard, keypad, mouse, pen, voice input device, touch input device, etc. Output device(s) 1174 such as a display, speakers, printer, etc. also can be included.

Movable wireless network 110, stationary wireless network 130, non-stationary wireless network 611, non-stationary wireless network 811, and/or GPRS core network 857 may comprise any appropriate telephony radio network, or any other type of communications network, or any combination thereof. The following description sets forth some exemplary telephony radio networks, such as the global system for mobile communications (GSM), and non-limiting operating environments. The below-described operating environments should be considered non-exhaustive, however, and thus the below-described network architectures merely show how IP cellular broadcast may be used with stationary and non-stationary network structures and architectures. It can be appreciated, however, that utilization of IP cellular broadcast systems can be incorporated with existing and/or future alternative architectures for communication networks as well.

The GSM is one of the most widely utilized wireless access systems in today's fast growing communication environment. The GSM provides circuit-switched data services to subscribers, such as mobile telephone or computer users. The General Packet Radio Service (GPRS), which is an extension to GSM technology, introduces packet switching to GSM networks. The GPRS uses a packet-based wireless communication technology to transfer high and low speed data and signaling in an efficient manner. The GPRS attempts to optimize the use of network and radio resources, thus enabling the cost effective and efficient use of GSM network resources for packet mode applications.

As one of ordinary skill in the art can appreciate, the exemplary GSM/GPRS environment and services described herein also can be extended to 3 G services, such as Universal Mobile Telephone System (UMTS), Frequency Division Duplexing (FDD) and Time Division Duplexing (TDD), High Speed Packet Data Access (HSPDA), cdma2000 1× Evolution Data Optimized (EVDO), Code Division Multiple Access-2000 (cdma2000 3×), Time Division Synchronous Code Division Multiple Access (TD-SCDMA), Wideband Code Division Multiple Access (WCDMA), Enhanced Data GSM Environment (EDGE), International Mobile Telecommunications-2000 (IMT-2000), Digital Enhanced Cordless Telecommunications (DECT), 4 G Services such as Long Term Evolution (LTE), etc., as well as to other network services that become available in time. In this regard, the techniques of the utilization of SMS, MMS, and/or cellular broadcast can be applied independently of the method of data transport, and do not depend on any particular network architecture, or underlying protocols.

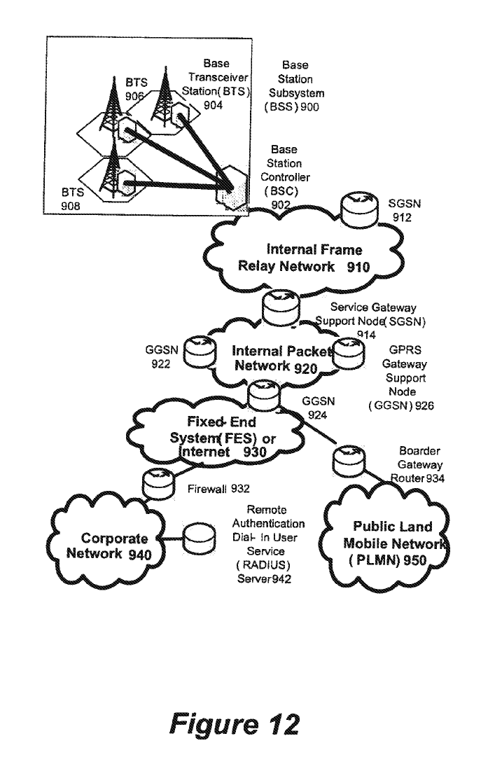

FIG. 12 depicts an overall block diagram of an exemplary packet-based mobile cellular network environment, such as a GPRS network, in which utilization of IP cellular broadcast systems to transmit and receive communications over a stationary and/or non-stationary wireless network can be practiced. In an example configuration, movable wireless network 110, stationary wireless network 130, non-stationary wireless network 611, non-stationary wireless network 811, and/or GPRS core network 857 may be encompassed by the network environment depicted in FIG. 12. In such an environment, there may be a plurality of Base Station Subsystems (BSS) 900 (only one is shown), each of which comprises a Base Station Controller (BSC) 902 serving a plurality of Base Transceiver Stations (BTS) such as BTSs 904, 906, and 908. BTSs 904, 906, 908, etc. are the access points where users of packet-based mobile devices (e.g., cell phones 833, wireless router 835, portable computer 837, and/or wireless communication devices 120 and 140) become connected to the wireless network. In exemplary fashion, the packet traffic originating from user devices (e.g., cell phones 833, wireless router 835, portable computer 837, and/or wireless communication devices 120 and 140) may be transported via an over-the-air interface to a BTS 908, and from the BTS 908 to the BSC 902. Base station subsystems, such as BSS 900, may be a part of internal frame relay network 910 that can include Service GPRS Support Nodes (SGSN) such as SGSN 912 and 914. Each SGSN may be connected to an internal packet network 920 through which a SGSN 912, 914, etc. may route data packets to and from a plurality of gateway GPRS support nodes (GGSN) 922, 924, 926, etc. As illustrated, SGSN 914 and GGSNs 922, 924, and 926 may be part of internal packet network 920. Gateway GPRS serving nodes 922, 924 and 926 may provide an interface to external Internet Protocol (IP) networks, such as Public Land Mobile Network (PLMN) 950, corporate intranets 940, or Fixed-End System (FES) or the public Internet 930. As illustrated, subscriber corporate network 940 may be connected to GGSN 924 via firewall 932; and PLMN 950 may be connected to GGSN 924 via boarder gateway router 934. The Remote Authentication Dial-In User Service (RADIUS) server 942 may be used for caller authentication when a user of a mobile cellular device calls corporate network 940.

Generally, there can be four different cell sizes in a GSM network, referred to as macro, micro, pico, and umbrella cells. The coverage area of each cell is different in different environments. Macro cells may be regarded as cells in which the base station antenna is installed in a mast or a building above average roof top level. Micro cells are cells whose antenna height is under average roof top level. Micro-cells may be typically used in urban areas. Pico cells are small cells having a diameter of a few dozen meters. Pico cells may be used mainly indoors. On the other hand, umbrella cells may be used to cover shadowed regions of smaller cells and fill in gaps in coverage between those cells.

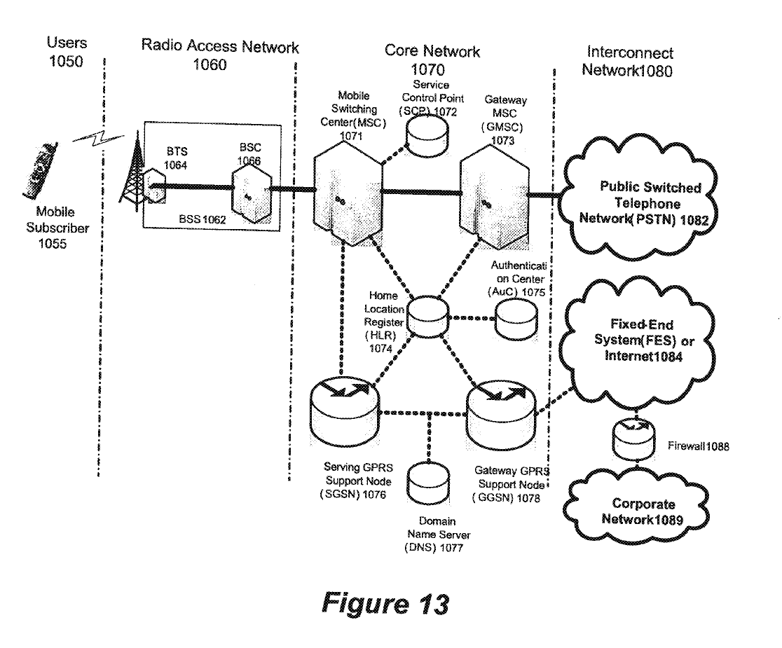

FIG. 13 illustrates an architecture of a typical GPRS network segmented into four groups: users 1050, radio access network 1060, core network 1070, and interconnect network 1080. Users 1050 may comprise a plurality of end users (though only mobile subscriber 1055 is shown in FIG. 13). In an example embodiment, the device depicted as mobile subscriber 1055 may comprise cell phones 833, wireless router 835, portable computer 837, and/or wireless communication devices 120 and 140. Radio access network 1060 comprises a plurality of base station subsystems such as BSSs 1062, which include BTSs 1064 and BSCs 1066. Core network 1070 comprises a host of various network elements. As illustrated here, core network 1070 may comprise Mobile Switching Center (MSC) 1071, Service Control Point (SCP) 1072, gateway MSC 1073, SGSN 1076, Home Location Register (HLR) 1074, Authentication Center (AuC) 1075, Domain Name Server (DNS) 1077, and GGSN 1078. Interconnect network 1080 may also comprise a host of various networks and other network elements. As illustrated in FIG. 13, interconnect network 1080 comprises Public Switched Telephone Network (PSTN) 1082, Fixed-End System (FES) or Internet 1084, firewall 1088, and Corporate Network 1089.

A mobile switching center may be connected to a large number of base station controllers. At MSC 1071, for instance, depending on the type of traffic, the traffic may be separated in that voice may be sent to Public Switched Telephone Network (PSTN) 1082 through Gateway MSC (GMSC) 1073, and/or data may be sent to SGSN 1076, which then sends the data traffic to GGSN 1078 for further forwarding.

When MSC 1071 receives call traffic, for example, from BSC 1066, it may send a query to a database hosted by SCP 1072. The SCP 1072 may process the request and may issue a response to MSC 1071 so that it may continue call processing as appropriate.

The HLR 1074 may be a centralized database for users to register to the GPRS network. HLR 1074 may store static information about the subscribers such as the International Mobile Subscriber Identity (IMSI), subscribed services, and a key for authenticating the subscriber. HLR 1074 may also store dynamic subscriber information such as the current location of the mobile subscriber. Associated with HLR 1074 may be AuC 1075. AuC 1075 may be a database that contains the algorithms for authenticating subscribers and may include the associated keys for encryption to safeguard the user input for authentication.

In the following, depending on context, the term “mobile subscriber” sometimes refers to the end user and sometimes to the actual portable device, such as cell phones 833, wireless router 835, portable computer 837, and wireless communication devices 120 and 140, used by an end user of the mobile cellular service. When a mobile subscriber turns on his or her mobile device, the mobile device may go through an attach process by which the mobile device attaches to an SGSN of the GPRS network. In FIG. 13, when mobile subscriber 1055 initiates the attach process by turning on the network capabilities of the mobile device, an attach request may be sent by mobile subscriber 1055 to SGSN 1076. The SGSN 1076 queries another SGSN, to which mobile subscriber 1055 was attached before, for the identity of mobile subscriber 1055. Upon receiving the identity of mobile subscriber 1055 from the other SGSN, SGSN 1076 may request more information from mobile subscriber 1055. This information may be used to authenticate mobile subscriber 1055 to SGSN 1076 by HLR 1074. Once verified, SGSN 1076 sends a location update to HLR 1074 indicating the change of location to a new SGSN, in this case SGSN 1076. HLR 1074 may notify the old SGSN, to which mobile subscriber 1055 was attached before, to cancel the location process for mobile subscriber 1055. HLR 1074 may then notify SGSN 1076 that the location update has been performed. At this time, SGSN 1076 sends an Attach Accept message to mobile subscriber 1055, which in turn sends an Attach Complete message to SGSN 1076.

After attaching itself with the network, mobile subscriber 1055 may then go through the authentication process. In the authentication process, SGSN 1076 may send the authentication information to HLR 1074, which may send information back to SGSN 1076 based on the user profile that was part of the user's initial setup. The SGSN 1076 may then send a request for authentication and ciphering to mobile subscriber 1055. The mobile subscriber 1055 may use an algorithm to send the user identification (ID) and password to SGSN 1076. The SGSN 1076 may use the same algorithm and compares the result. If a match occurs, SGSN 1076 authenticates mobile subscriber 1055.

Next, the mobile subscriber 1055 may establish a user session with the destination network, corporate network 1089, by going through a Packet Data Protocol (PDP) activation process. Briefly, in the process, mobile subscriber 1055 may request access to the Access Point Name (APN), for example, UPS.com, and SGSN 1076 may receive the activation request from mobile subscriber 1055. SGSN 1076 may then initiate a Domain Name Service (DNS) query to learn which GGSN node has access to the UPS.com APN. The DNS query may be sent to the DNS server within the core network 1070, such as DNS 1077, which may be provisioned to map to one or more GGSN nodes in the core network 1070. Based on the APN, the mapped GGSN 1078 can access the requested corporate network 1089. The SGSN 1076 may then send to GGSN 1078 a Create Packet Data Protocol (PDP) Context Request message that contains necessary information. The GGSN 1078 may send a Create PDP Context Response message to SGSN 1076, which may then send an Activate PDP Context Accept message to mobile subscriber 1055.

Once activated, data packets of the call made by mobile subscriber 1055 may then go through radio access network 1060, core network 1070, and interconnect network 1080, in a particular fixed-end system, or Internet 1084 and firewall 1088, to reach corporate network 1089.

Thus, network elements that can invoke the functionality of utilization of IP cellular broadcast systems to operate and configure stationary and non-stationary wireless networks can include but are not limited to Gateway GPRS Support Node tables, Fixed End System router tables, firewall systems, VPN tunnels, and any number of other network elements as required by the particular digital network.

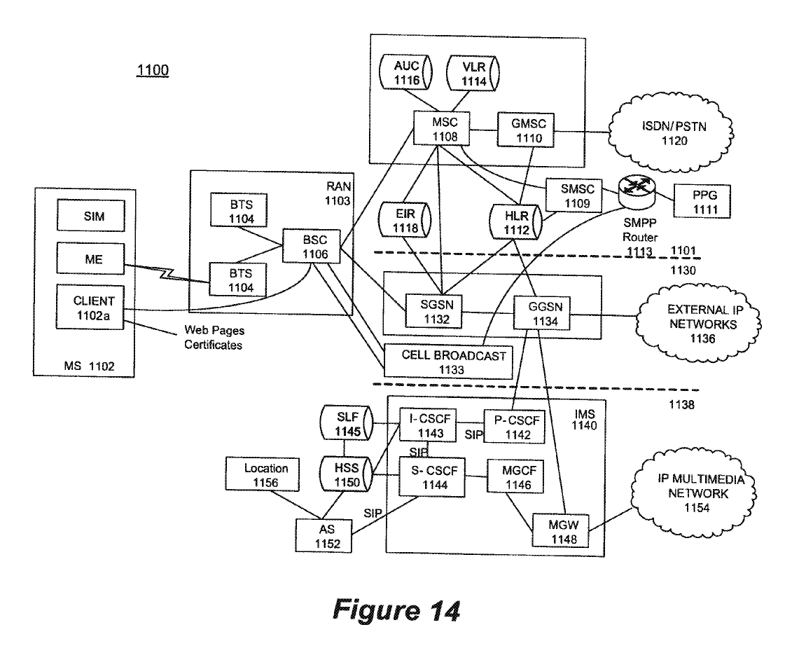

FIG. 14 illustrates another exemplary block diagram view of a GSM/GPRS/IP multimedia network architecture 1100 with which the utilization of IP cellular broadcast systems to operate and configure stationary and non-stationary wireless networks can be incorporated. As illustrated, architecture 1100 of FIG. 14 includes a GSM core network 1101, a GPRS network 1130 and an IP multimedia network 1138. The GSM core network 1101 includes a Mobile Station (MS) 1102, at least one Base Transceiver Station (BTS) 1104 and a Base Station Controller (BSC) 1106. The MS 1102 is physical equipment or Mobile Equipment (ME), such as a mobile telephone or a laptop computer (e.g., cell phones 833, wireless router 835, portable computer 837, and/or wireless communication devices 120 and 140) that is used by mobile subscribers, with a Subscriber identity Module (SIM). The SIM includes an International Mobile Subscriber Identity (IMSI), which is a unique identifier of a subscriber. The BTS 1104 may be physical equipment, such as a radio tower, that enables a radio interface to communicate with the MS. Each BTS may serve more than one MS. The BSC 1106 may manage radio resources, including the BTS. The BSC may be connected to several BTSs. The BSC and BTS components, in combination, are generally referred to as a base station (BSS) or radio access network (RAN) 1103.

The GSM core network 1101 may also include a Mobile Switching Center (MSC) 1108, a Gateway Mobile Switching Center (GMSC) 1110, a Home Location Register (HLR) 1112, Visitor Location Register (VLR) 1114, an Authentication Center (AuC) 1118, and an Equipment Identity Register (EIR) 1116. The MSC 1108 may perform a switching function for the network. The MSC may also perform other functions, such as registration, authentication, location updating, handovers, and call routing. The GMSC 1110 may provide a gateway between the GSM network and other networks, such as an Integrated Services Digital Network (ISDN) or Public Switched Telephone Networks (PSTNS) 1120. Thus, the GMSC 1110 provides interworking functionality with external networks.

The HLR 1112 is a database that may contain administrative information regarding each subscriber registered in a corresponding GSM network. The HLR 1112 may also contain the current location of each MS. The VLR 1114 may be a database that contains selected administrative information from the HLR 1112. The VLR may contain information necessary for call control and provision of subscribed services for each MS currently located in a geographical area controlled by the VLR. The HLR 1112 and the VLR 1114, together with the MSC 1108, may provide the call routing and roaming capabilities of GSM. The AuC 1116 may provide the parameters needed for authentication and encryption functions. Such parameters allow verification of a subscriber's identity. The EIR 1118 may store security-sensitive information about the mobile equipment.

A Short Message Service Center (SMSC) 1109 allows one-to-one short message service (SMS), or multimedia message service (MMS), messages to be sent to/from the MS 1102. A Push Proxy Gateway (PPG) 1111 is used to “push” (i.e., send without a synchronous request) content to the MS 1102. The PPG 1111 acts as a proxy between wired and wireless networks to facilitate pushing of data to the MS 1102. A Short Message Peer to Peer (SMPP) protocol router 1113 may be provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, short message service (SMS), and multimedia message service (MMS), the MS may first register with the network to indicate its current location by performing a location update and IMSI attach procedure. The MS 1102 may send a location update including its current location information to the MSC/VLR, via the BTS 1104 and the BSC 1106. The location information may then be sent to the MS's HLR. The HLR may be updated with the location information received from the MSC/VLR. The location update may also be performed when the MS moves to a new location area. Typically, the location update may be periodically performed to update the database as location updating events occur.

The GPRS network 1130 may be logically implemented on the GSM core network architecture by introducing two packet-switching network nodes, a serving GPRS support node (SGSN) 1132, a cell broadcast and a Gateway GPRS support node (GGSN) 1134. The SGSN 1132 may be at the same hierarchical level as the MSC 1108 in the GSM network. The SGSN may control the connection between the GPRS network and the MS 1102. The SGSN may also keep track of individual MS's locations and security functions and access controls.

A Cell Broadcast Center (CBC) 1133 may communicate cell broadcast messages that are typically delivered to multiple users in a specified area. Cell Broadcast is one-to-many geographically focused service. It enables messages to be communicated to multiple mobile telephone customers who are located within a given part of its network coverage area at the time the message is broadcast.

The GGSN 1134 may provide a gateway between the GPRS network and a public packet network (PDN) or other IP networks 1136. That is, the GGSN may provide interworking functionality with external networks, and set up a logical link to the MS through the SGSN. When packet-switched data leaves the GPRS network, it may be transferred to an external TCP-IP network 1136, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services may be used in parallel. The MS may operate in one three classes: class A, class B, and class C. A class A MS may attach to the network for both GPRS services and GSM services simultaneously. A class A MS may also support simultaneous operation of GPRS services and GSM services. For example, class A mobiles may receive GSM voice/data/SMS calls and GPRS data calls at the same time.

A class B MS may attach to the network for both GPRS services and GSM services simultaneously. However, a class BMS does not support simultaneous operation of the GPRS services and GSM services. That is, a class BMS can only use one of the two services at a given time.

A class C MS can attach for only one of the GPRS services and GSM services at a time. Simultaneous attachment and operation of GPRS services and GSM services is not possible with a class CMS.

A GPRS network 1130 may be designed to operate in three network operation modes (NOM1, NOM2 and NOM3). A network operation mode of a GPRS network may be indicated by a parameter in system information messages transmitted within a cell. The system information messages may direct a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not receive pages from a circuit switched domain when engaged in a data call, since the MS is receiving data and is not listening to a paging channel. In a NOM3 network, a MS can monitor pages for a circuit switched network while receiving data and vise versa.

The IP multimedia network 1138 was introduced with 3 GPP Release 5, and may include an IP multimedia subsystem (IMS) 1140 to provide rich multimedia services to end users. A representative set of the network entities within the IMS 1140 are a call/session control function (CSCF), a media gateway control function (MGCF) 1146, a media gateway (MGW) 1148, and a master subscriber database, called a home subscriber server (HSS) 1150. The HSS 1150 may be common to the GSM network 1101, the GPRS network 1130 as well as the IP multimedia network 1138.

The IP multimedia system 1140 may be built around the call/session control function, of which there are three types: an interrogating CSCF (I-CSCF) 1143, a proxy CSCF (P-CSCF) 1142, and a serving CSCF (S-CSCF) 1144. The P-CSCF 1142 is the MS's first point of contact with the IMS 1140. The P-CSCF 1142 may forward session initiation protocol (SIP) messages received from the MS to an SIP server in a home network (and vice versa) of the MS. The P-CSCF 1142 may also modify an outgoing request according to a set of rules defined by the network operator (for example, address analysis and potential modification).

The I-CSCF 1143 forms an entrance to a home network and hides the inner topology of the home network from other networks and provides flexibility for selecting an S-CSCF. The I-CSCF 1143 may contact a subscriber location function (SLF) 1145 to determine which HSS 1150 to use for the particular subscriber, if multiple HSSs 1150 are present. The S-CSCF 1144 may perform the session control services for the MS 1102. This includes routing originating sessions to external networks and routing terminating sessions to visited networks. The S-CSCF 1144 may also decide whether an application server (AS) 1152 is required to receive information on an incoming SIP session request to ensure appropriate service handling. This decision is based on information received from the HSS 1150 (or other sources, such as an application server 1152). The AS 1152 may also communicate to a location server 1156 (e.g., a Gateway Mobile Location Center (GMLC)) that provides a position (e.g., latitude/longitude coordinates) of the MS 1102.

The HSS 1150 may contain a subscriber profile and keep track of which core network node is currently handling the subscriber. It may also support subscriber authentication and authorization functions (AAA.) In networks with more than one HSS 1150, a subscriber location function provides information on the HSS 1150 that contains the profile of a given subscriber.

The MGCF 1146 may provide interworking functionality between SIP session control signaling from the IMS 1140 and ISUP/BICC call control signaling from the external GSTN networks (not shown.) It may also control the media gateway (MGW) 1148 that provides user-plane interworking functionality (e.g., converting between AMR- and PCM-coded voice.) The MGW 1148 may also communicate with other IP multimedia networks 1154.

Push to Talk over Cellular (PoC) capable mobile telephones may register with the wireless network when the telephones are in a predefined area (e.g., job site, etc.) When the mobile telephones leave the area, they may register with the network in their new location as being outside the predefined area. This registration, however, does not indicate the actual physical location of the mobile telephones outside the pre-defined area.

While example embodiments of the utilization of IP cellular broadcast systems to receive/transmit wireless communications have been described in connection with various computing devices/processor, the underlying concepts can be applied to any computing device, processor, or system capable of utilizing IP cellular broadcast systems to receive/transmit wireless communications. The various techniques described herein can be implemented in connection with hardware or software or, where appropriate, with a combination of both. Thus, the methods and apparatuses for the utilization of IP cellular broadcast systems to receive/transmit wireless communications, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for the utilization of IP cellular broadcast systems to receive/transmit wireless communications. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses for the utilization of IP cellular broadcast systems to receive/transmit wireless communications also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for the utilization of IP cellular broadcast systems to receive/transmit wireless communications. When implemented on a general-purpose processor, the program code combines with the processor to provide a unique apparatus that operates to invoke the functionality of the utilization of IP cellular broadcast systems to receive/transmit wireless communications. Additionally, any storage techniques used in connection with the utilization of IP cellular broadcast systems to receive/transmit wireless communications can invariably be a combination of hardware and software.

While the utilization of IP cellular broadcast systems to receive/transmit wireless communications has been described in connection with the various embodiments of the various figures, it is to be understood that other similar embodiments can be used or modifications and additions can be made to the described embodiment for performing the same function of utilizing IP cellular broadcast systems to receive/transmit wireless communications without deviating therefrom. For example, one skilled in the art will recognize that the utilization of IP cellular broadcast systems to receive/transmit wireless communications as described in the present application may apply to any environment, whether wired or wireless, and may be applied to any number of such devices connected via a communications network and interacting across the network. Therefore, the utilization of IP cellular broadcast systems to receive/transmit wireless communications should not be limited to any single embodiment, but rather should be construed in breadth and scope in accordance with the appended claims.

The immediate benefits of the present subject matter are to provide a top-level control of the non-stationary wireless network, but it is foreseeable that this type of system could be employed for many other similar networks or even future location based services.

Other applications for this type of system may exist in areas such as location-based services or in other sectors of industry that transport people who are in need of data and voice communication.

What is Claimed:

1. A method of controlling a non-stationary wireless network having a mobile base station, and at least one wireless appliance, said method comprising:
determining a location of a mobile base station;
ascertaining regulatory requirements for the location;
determining if the operating settings for the for the mobile base station are the same as the regulatory requirements for the location; and
changing the operating settings of the mobile base station to conform with the regulatory requirements for said location if the regulatory requirements are different that the operating setting.

2. The method of claim 1 wherein said step of determining the location of the mobile base station comprises using a global positioning system to determine the location of the mobile base station.

3. The method of claim 1 wherein said step of ascertaining the regulatory requirements comprises accessing a database of regulatory requirements associated with ranges of locations and returning a set of regulatory requirements associated with the location of the mobile base station

4. The method of claim 3 wherein said regulatory requirements comprise at least one of a frequency, a power, a mode of communication, and a permitted class of emissions.

5. The method of claim 1 wherein said step of changing the operating settings comprises instructing a controller to set the operating settings to settings conforming to the regulatory requirements.

6. A wireless network comprising:
a mobile base station;
at least one wireless appliance in proximity to the mobile base station;
means for determining a location of the mobile base station;
means for ascertaining at least one regulatory requirement for the location of the mobile base station; and
means for changing the operating settings for said mobile base station to conform to said at least one regulatory requirements.

7. The network of claim 6 wherein said mobile base station comprises:
a radio frequency transceiver;
a controller and
a CPU.

8. The network of claim 6 wherein said wireless appliance comprises a cell phone.

9. The network of claim 6 wherein said wireless network appliance comprises a wireless router.

10. The network of claim 6 wherein said means for determining the location of the mobile base station comprises using a GPS receiver to determine the location of the mobile base station.

11. The network of claim 6 wherein said means for ascertaining the regulatory requirements comprises:
a database having a table of ranges of locations and regulatory requirements applicable with each of those ranges of locations;
means for identifying which of the ranges of locations is associated with the location of the mobile base station; and
means for returning values of regulatory requirements associated with the location of the mobile base station.

12. The network of claim 11 wherein said regulatory requirements include at least one of a frequency, a power, a mode of communication, and a permitted class of emissions.

13. A network comprising
a first plurality of stationary base stations at a first location, said first plurality of stationary base stations operating in conformance with the regulatory requirements for said first location;
a second plurality of stationary base stations at a second location, said second plurality of stationary base stations operating in conformance with the regulatory requirements for said second location, wherein the regulatory requirements for the first location are different that the regulatory requirements for the second location,
a mobile base station with operating settings operating in conformance with the regulatory requirements for said first location;
at least one wireless appliance in two-way communication with the mobile base station;
means for determining the location of the mobile base station
means for changing the operating settings of the mobile base station to conform to the regulatory requirements of said second location when the mobile base station enters the second location.

14. The network of claim 13 wherein the mobile base station comprises a radio frequency transceiver.

15. The network of claim 14 wherein the operating settings of said mobile base station include at least one of a frequency, a power, a mode of communication, and a permitted class of emissions of said transceiver.

16. The network of claim 13 wherein said means for changing the operating settings of the mobile base station comprises;
a CPU;
software operating in the CPU;
means for storing regulatory requirements information associated with a range of locations, said means for storing being accessible by the software.

17. The network of claim 16 wherein said software comprises:
means for searching the range of locations to determine which range of locations the location of the mobile base stations falls under;
means for returning regulatory requirement information to the CPU; and
means for providing a signal to change the operating settings of said mobile base station.

18. The network of claim 17 further comprising:
a controller responsive to said means for providing a signal.

19. The network of claim 17 wherein said means for storing regulatory requirements comprises:
a database having a set of regulatory requirements associated with a range of location coordinates.
